(19) United States
(12) Patent Application Publication
(10) Pub. No.: US 2013/0112841 A1
(43) Pub. Date: May 9, 2013

(54) SUPPORTING APPARATUS

(71) Applicant: Eagle Fan, Hsinchu (TW)

(72) Inventor: Eagle Fan, Hsinchu (TW)

(21) Appl. No.: 13/292,341

(22) Filed: Nov. 9, 2011

(51) Int. Cl. F16M 13/00; F16M 11/00

(52) U.S. Cl. 248/622; 248/126

(57) ABSTRACT

A support apparatus is provided, including an insertion unit and a support unit. The shape of insertion unit is smaller at bottom and increasingly bigger towards the top. The insertion unit includes a side wall to be pushed to move and a resilient element for providing a force to restore the position of side wall when side wall is pushed to move. The support unit includes a first end and a second end. The shape of support unit includes a support arm extending upwards. The first end is coupled to the top position of insertion unit. The second end is for connecting an element to be fixed to the support apparatus. The position of second end is adjustable. The insertion unit can be inserted into a gap between a seat and a central armrest. The support unit can support a portable electronic device for use in vehicle.

### FIELD OF THE INVENTION

The present invention generally relates to a supporting apparatus, and more specifically to a supporting apparatus being inserted into and fixed inside a gap between a seat and a central hand rest in a vehicle to support a portable electronic device for using in the vehicle.

### BACKGROUND OF THE INVENTION

As the touch panel technology matures and various applications are developed, the popularity trend of tablet PC is inevitable. Small size and portability enables the user to carry and use tablet PC everywhere, indoors and outdoors alike, even in various moving transportation vehicles.

In addition to tablet PC, other portable electronic devices are also gaining popularity, such as, smart cellular device, PDA, portable media player (PMP), e-Book reader, mobile internet device (MID), smart book, media tablet, and so on.

Currently, if a user intends to use a portable device inside a vehicle, the user usually must install a suction-disc support device or auxiliary fixing device to hold the portable device in the space between the top of the dashboard and windshield. However, This placement may hinder the view of the driver and cause danger to the driving. Therefore, the inventor seeks for another plausible location inside the vehicle and designs a support apparatus for utilizing such location for holding and placing a portable electronic device.

### SUMMARY OF THE INVENTION

The primary object of the present invention is to provide a support apparatus to be installed near a hand rest in the front seat of a vehicle, by being inserted into a gap into a gap between the front passenger seat and the central hand rest to form a support frame, in combination with an auxiliary clamp device engaged to the support apparatus, to provide support to a portable electronic device. The portable electronic device can be set up on the side of the driver seat without blocking the driver's view. In addition, the location also allows more convenience for the drive to operate the portable electronic device.

To achieve the above object, the present invention provides a support apparatus, including an insertion unit and a support unit. The shape of the insertion unit is smaller at the bottom and increasingly bigger towards the top. At least a side wall forming the shape can be pushed to move. The inside of the insertion unit includes at least a resilient element. The resilient element provides the force to restore the position of the side wall when the side wall is pushed to move. The support unit includes a first end and a second end. The shape of the support unit includes at least a support arm extending upwards. The first end is coupled to the top position of the insertion unit. The second end is for connecting the element to be fixed to the support apparatus. The position of the second end can be adjusted.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the present invention;

FIG. 2 shows a cross-section partial view of the present invention;

FIG. 3 shows a top view of the present invention, with dash line indicating the adjusting state of the support unit;

FIG. 4 shows a side view of the present invention, with dash line indicating the adjusting state of second support arm of support unit;

FIG. 5 shows a schematic view of the structure of the coupling joint of second support arm and third support arm;

FIG. 6 shows a side view of the folded support apparatus of the present invention; and

FIG. 7 shows a schematic view of the actual application of the present invention.

### DETAILED DESCRIPTION OF THE PREFERRED EMBODIMENTS

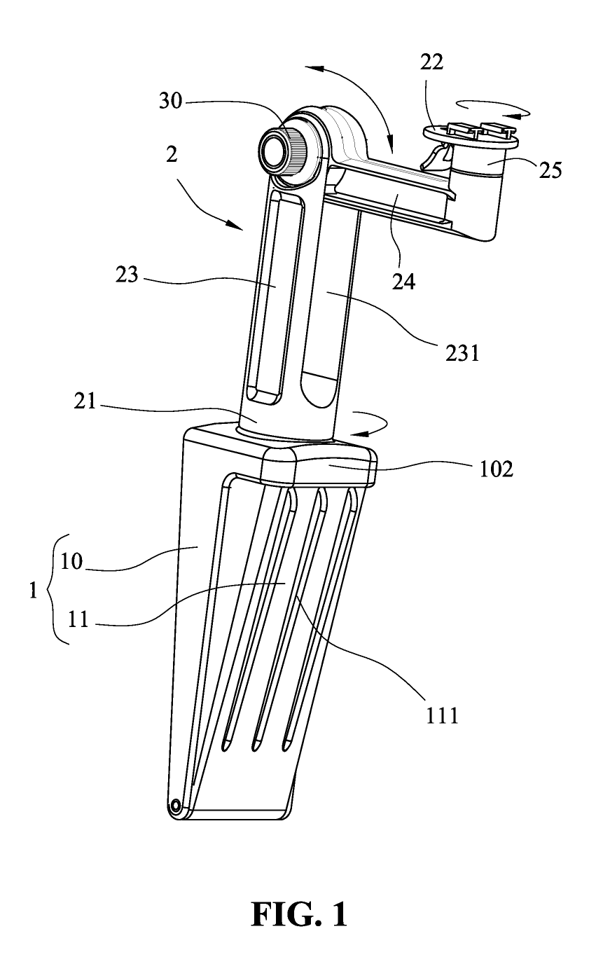

FIG. 1 shows a schematic view of the present invention. A support apparatus includes an insertion unit 1 and a support unit 2. The shape of insertion unit 1 is smaller at the bottom and increasingly bigger towards the top, and includes a side wall 11 that can be pushed to move and a resilient element 12 for providing the force to restore the position of side wall 11 when side wall is pushed 11 to move. Support unit 2 serves as an extending and supporting structure between insertion unit 1 and an element to be fixed to the apparatus, and includes a first end 21 and a second end 22. First end 21 is coupled to the top position of insertion unit 1. The position of second end 22 can be adjusted so that the fixed element can be used for optimal result, such as, angle or direction. The fixed element can be a clipping device for clipping a portable electronic device or an auxiliary supporting frame. For use, insertion unit 1 is inserted into a gap between the seat and the central armrest inside a vehicle. Support unit 2 is for supporting the portable electronic device to be used inside the vehicle.

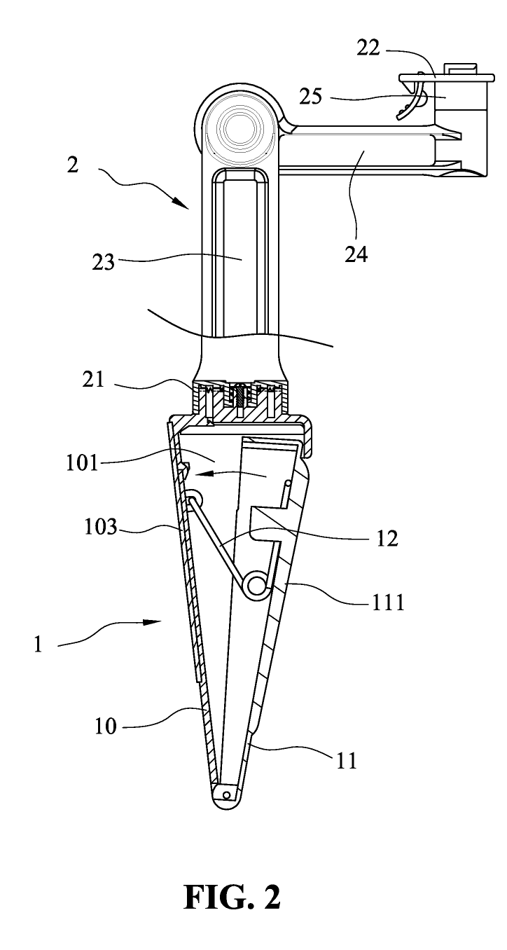

As shown in FIG. 1 and FIG. 2, the shape of insertion unit 1 is formed by a shell base 10 and a side wall 11. Shell base 10 includes a non-closed cavity 101. The bottom of side wall 11 is coupled with the bottom of shell base 10, and side wall 11 is located at the non-closed opening of cavity 101. Side wall 11 is constrained to move inside cavity 101, and can only move deeper into cavity 101 (to the left of FIG. 2). When side wall 11 is pushed to move, the middle section of insertion unit 1 becomes narrower. Resilient element 12 is a torque spring, and is constrained between shell base 10 and side wall 11 to provide a force to restore the position of side wall 11 after pushed to move. The side view of shell base 10 is an upside down L-shape, with a fix frame 102 at the top. The movement of side wall 11 is underneath fix frame 102. The upside down L-shape of shell base 10 enables a firmer insertion.

In addition, to increase the friction between the surface of insertion unit 1 and contact surface after insertion, the outside wall of the largest area of base shell 10 further includes an anti-slip layer 103 and the outside wall of the largest area of side wall inside the vehicle and protruding stripes 111 can increase the friction after insertion.

Support unit 2 serves as the extending upwards supporting arm for insertion unit 1 to engage another element at second end 22. The position of second end 22 is adjustable so that a portable electronic device engaged to second end 22 of support unit 2 can be adjusted for optimal view angle and position. Because the element may vary in design, the following embodiment is only exemplary instead of restrictive.

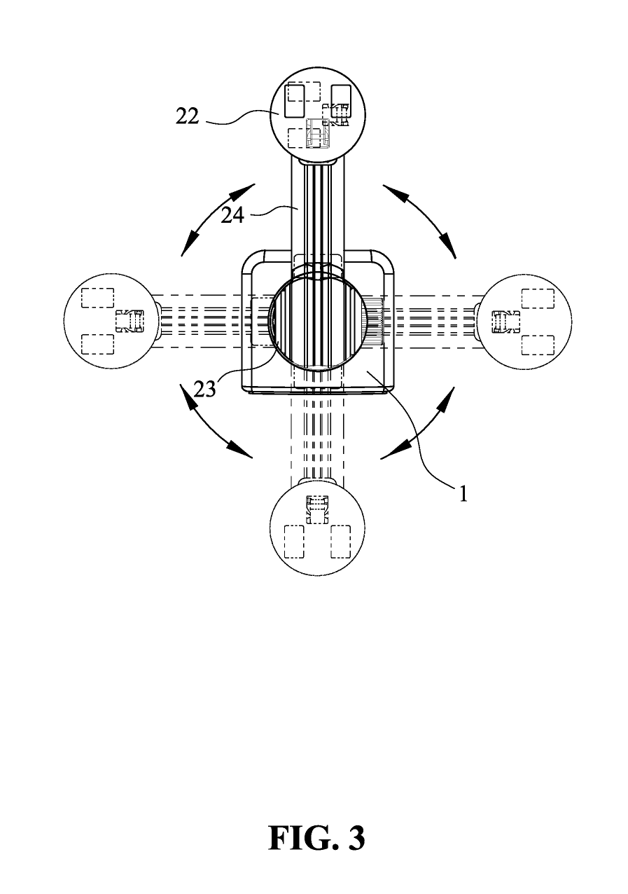

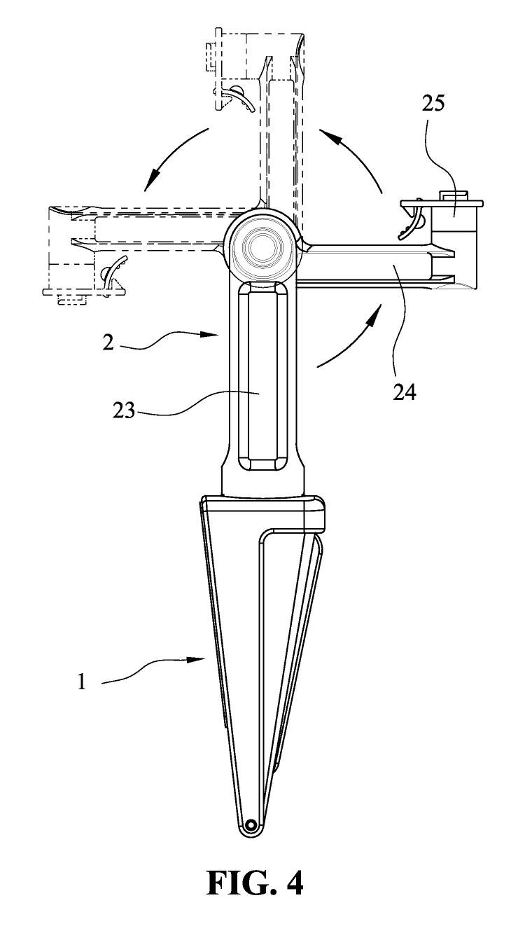

As shown in FIG. 1, FIG. 3 and FIG. 4, support unit 2 includes at least two support arms. In the present embodiment, support unit 2 includes a first support arm 23, a second support arm 24, and a third support arm 25, with each support arm coupled in sequence so that each support arm can be adjusted for different angle. The joint connecting support arms includes a lock element for locking in the adjusted support arm positions so as to adjust the position of second end 22 in relation to first end 21.

For full adjustment, support unit 2 of the present invention includes three-axial adjustment. The first axial is to use first support arm 23 to couple to the top of insertion unit 1, as shown in FIG. 3. With the coupling axis as the center, the entire support unit 2 can be adjusted in 360°. The dash line in FIG. 3 shows the position after adjustment. The second axial is to use the coupling of first support arm 23 and second support arm 24, as shown in FIG. 4. By adjusting the angle of second support arm 24, the position of second end 22 can be changed. The third axial is to use the coupling of second support arm 24 and third support arm 25. By rotating third support arm 25, the position and orientation of second end 22 on third support arm 25 can be changed, shown as the dash line in FIG. 3. In addition, the structure and shape of second end 22 must match the element to be engaged, instead of limited to a fixed type.

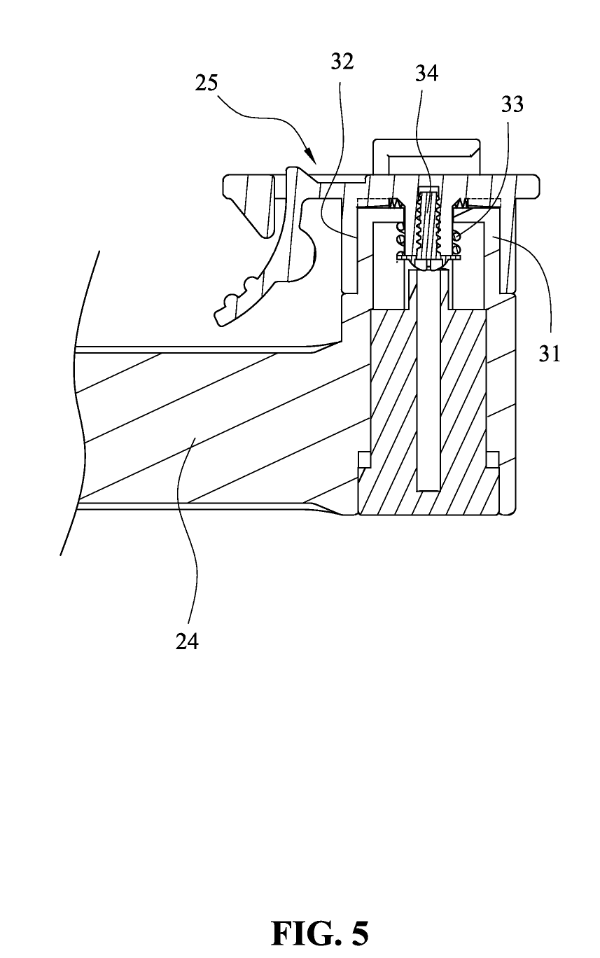

The lock element of the present embodiment is for locking in the positions of each support arm after adjustment and is not limited to any specific type. For example, the lock element at the joint of first support arm 23 and second support arm 24 is a rotation knob 30. When rotation knob 30 is loosened, two support arms can be adjusted for different angle. On the other hand, when rotation knob 30 is tightened, the relative position of the two support arms is locked. The joint of first support arm 23 and insertion unit 2 and the joint of third support arm 25 and second support arm 24 use a different type of lock element. As shown in FIG. 5, the lock element includes an axial element 31 located at second support arm 24, an axial base 32 located at third support arm 25, a spring 33 and a screw latch 34. The end surface of axial element 31 contacting axial base 32 forms radiant teeth, shown as dash line distribution in FIG. 5. For assembly, screw latch 34 locks axial base 32 and spring 33 maintains the contact of axial element 31 and teeth surface of axial base 32. For angle adjustment, if an applied force is greater than the spring force of spring 33, third support arm 25 can be rotated. When the applied force stops, the relative position of third support arm 25 and second support arm 24 is fixed. As the exemplary embodiment shows, the lock element of the present invention is not limited to any specific type. Any equivalent structure able to lock the coupling of support arms can be used as a lock element of the present invention.

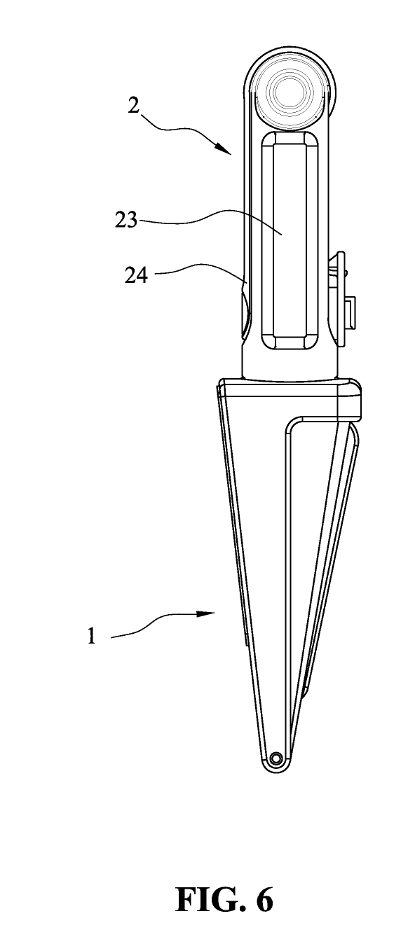

As shown in FIG. 1 and FIG. 6, a space 231 exists in first support arm 23. The shape of space 231 matches the shape of second support arm 24 so that second support arm 24 can be folded and housed inside space 231 of first support arm 23 for convenient portability and storage.

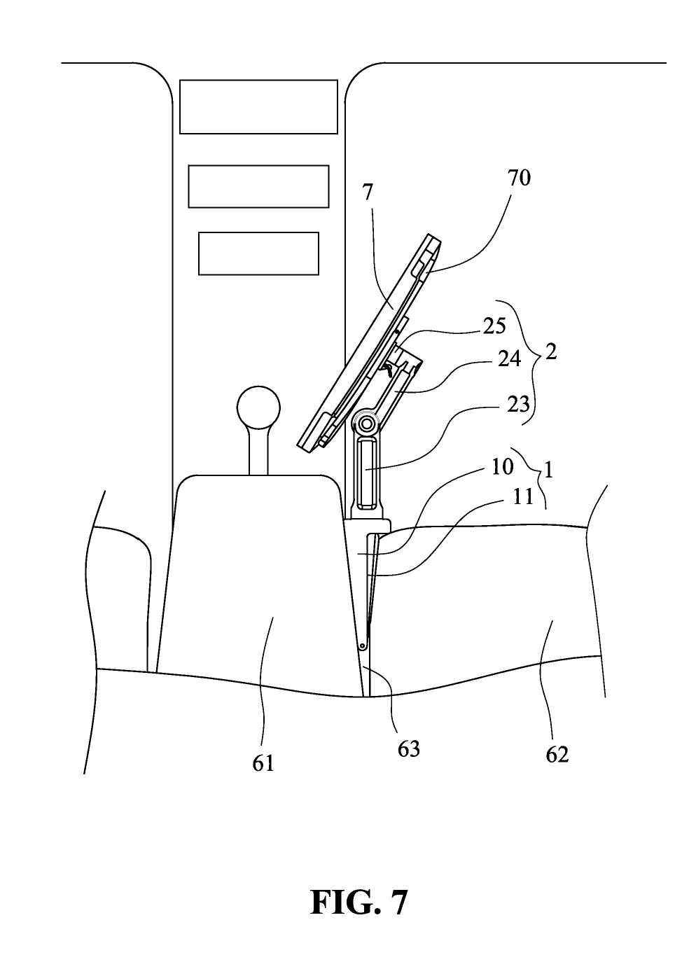

FIG. 7 shows a schematic view of an actual application of the present invention. In the present exemplar, the support apparatus of the present invention is inserted into gap 63 between central armrest 61 and front passenger seat 62 to provide support to a support frame to hold a portable device, such as, tablet PC. However, the location of insertion is not limited to the above exemplar. Insertion unit 1 is inserted into gap 63, with shell base 10 contacting outer wall of armrest 61, and side wall 11 contacting seat 62. Side wall 11 retracts due to the push from seat 62. Because insertion unit 61 has a resilient element 12 to apply force on side wall 11, leading to side wall pushed against seat 62 to maintain tight insertion of insertion unit 1. Because fix frame 102 of shell base 10 contacts the top surface of seat 62 to apply vertical force on top surface of seat 62, insertion unit 1 can maintain steady and firm insertion. In the present embodiment, a support tray 70 fastening a tablet PC 7, and support tray 70 is engaged to second end 22 of support unit 2. By adjusting first support arm 23, second support arm 24 and third support arm 25, tablet PC 7 can be set up on one side of the gear area for use inside the vehicle.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A support apparatus, comprising:
an insertion unit, having a shape smaller at bottom and increasingly bigger towards top, a side wall forming said insertion unit being able to be pushed to move and a resilient element inside for providing a force to restore position of said side wall when said side wall pushed to move; and
a support unit, having a first end and a second end, said first end coupled to top position of said insertion unit, said second end being for connecting an element to be fixed to said support apparatus, and position of said second end being adjustable.

2. The support apparatus as claimed in claim 1, wherein said insertion unit comprises a shell base having anon-closed cavity, bottom of said side wall is coupled to bottom of said shell base, said side wall is located at opening of said non-closed cavity and is constrained to move inside said cavity, and said shell base and said side wall form said shape smaller at bottom and increasingly bigger towards top.

3. The support apparatus as claimed in claim 1, wherein said side wall can only move into cavity, and when said side wall is pushed to move, middle section of said insertion unit becomes narrower than prior to push.

4. The support apparatus as claimed in claim 2, wherein said resilient element is a torque spring and constrained between the walls of said side wall and said shell base.

5. The support apparatus as claimed in claim 2, wherein outer wall of the largest area of said shell base further comprises an anti-slip layer.

6. The support apparatus as claimed in claim 1, wherein outer wall of the largest area of said side wall further forms a plurality of protruding stripes.

7. The support apparatus as claimed in claim 1, wherein said support unit comprises at least two support arms coupled in sequence, each coupling joint of said support arms comprises a lock element for locking in position of said support arm after adjustment, the last support arm of said support unit is coupled to top of said insertion unit.

8. The support apparatus as claimed in claim 7, wherein said last support arm of said support unit comprises a space with a shape matching the shape of a support arm coupling said last support arm.
